(19) United States
(12) Patent Application Publication
(10) Pub. No.: US 2017/0125919 A1
(43) Pub. Date: May 4, 2017

(54) MULTIPLE POLARIZED ANTENNA

(71) Applicant: GEMTEK TECHNOLOGY CO.,LTD., Hsinchu (TW)

(72) Inventors: Hsiao-Ching CHIEN, Hsinchu (TW); Hsu-Sheng WU, Hsinchu (TW); Chung-Kai YANG, Hsinchu (TW)

(73) Assignee: GEMTEK TECHNOLOGY CO.,LTD., Hsinchu (TW)

(21) Appl. No.: 15/157,351

(22) Filed: May 17, 2016

Related U.S. Application Data
(60) Provisional application No. 62/247,377, filed on Oct. 28, 2015.

(51) Int. Cl. H01Q 21/24; H01Q 1/12; H01Q 1/48

(52) U.S. Cl. CPC H01Q 21/24; H01Q 1/48; H01Q 1/12

(57) ABSTRACT

A polarized antenna includes a load board, a first radiation plate, M pieces of feeding part and N pieces of grounded part. The load board includes a conductive layer, and the first radiation plate is located above the load board and has a first resonance gap with the conductive layer. The M pieces of feeding part are located under the first radiation plate and are insulated from the conductive layer, and at least a part of each feeding part is covered by the first radiation plate and is used to have signal transmission with the first radiation plate. M is a positive integer larger than 2. The N pieces of grounded part are located on the load board and electrically connected to the conductive layer, and N is a positive integer larger than 1.

### CROSS-REFERENCE TO RELATED APPLICATIONS

This non-provisional application claims priority under 35 U.S.C. §119(a) on Patent Application No(s). 62/247,377 filed in the United States on Oct. 28, 2015, the entire contents of which are hereby incorporated by reference.

### BACKGROUND

Technical Field

The disclosure relates to a polarized antenna, more particularly to a polarized antenna including more than two feeding parts.

Related Art

Electromagnetic waves radiated from an antenna consist of electric and magnetic fields, and the direction of the electric field is defined as the direction of polarization. An antenna having a different direction of polarization can receive and transmit electromagnetic waves in the same direction. If the direction of polarization of an antenna differs from the direction of polarization of an electromagnetic wave received by the antenna, a polarization loss will occurs, so the signal energy obtained by the antenna will smaller than the inherent signal energy of the electromagnetic wave.

To reduce the occurrence of a polarization loss, various types of antenna elements have been designed to receive electromagnetic waves with a variety of directions of electric field. However, electronic devices nowadays have been designed to be lighter and slimmer than before, so the space provided by such an electronic device to accommodate an antenna is limited. Therefore, it is difficult for an antenna to take care of having multi-directions of polarization and having good receiver insulation.

### SUMMARY

The disclosure provides a polarized antenna to resolve the above problems.

According to one or more embodiments, a polarized antenna includes a load board, first radiation plate, M pieces of feeding part and N pieces of grounded part. The load board includes a conductive layer. The first radiation plate is located above the load board, and the first radiation plate and the conductive layer have a first resonance gap therebetween. The M pieces of feeding part are located under the first radiation plate and insulated from the conductive layer. At least a part of each of the feeding parts is covered by and located under the first radiation plate and is applicable to have signal transmission with the first radiation plate. M is a positive integer larger than 2. The N pieces of grounded part are located on the load board and electrically connected to the conductive layer. N is a positive integer larger than 1.

In the polarized antenna of the disclosure, more than two feeding parts are disposed to receive electromagnetic waves in a variety of directions of electric field, and more than two grounded parts are disposed to enhance the receiver insulation.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1A is a perspective view of the first embodiment of a polarized antenna in the disclosure;

FIG. 1B is a side view of the first embodiment of a polarized antenna in the disclosure;

FIG. 1C is a top view of the first embodiment of a polarized antenna in the disclosure;

FIG. 2 is a side view of the second embodiment of a polarized antenna in the disclosure;

FIG. 3 is a side view of the third embodiment of a polarized antenna in the disclosure;

FIG. 4 is a side view of the fourth embodiment of a polarized antenna in the disclosure;

FIG. 5 is a side view of the fifth embodiment of a polarized antenna in the disclosure;

FIG. 6 is a side view of the sixth embodiment of a polarized antenna in the disclosure;

FIG. 7 is a side view of the seventh embodiment of a polarized antenna in the disclosure;

FIG. 8 is a top view of the eighth embodiment of a polarized antenna in the disclosure;

FIG. 9 is a top view of the ninth embodiment of a polarized antenna in the disclosure;

FIG. 10 is a top view of the tenth embodiment of a polarized antenna in the disclosure;

FIG. 11 is a perspective view of the eleventh embodiment of a polarized antenna in the disclosure;

FIG. 12 is a perspective view of the twelfth embodiment of a polarized antenna in the disclosure;

FIG. 13 is a perspective view of the thirteenth embodiment of a polarized antenna in the disclosure;

FIG. 14 is a top view of the fourteenth embodiment of a polarized antenna in the disclosure;

FIG. 15 is a top view of the fifteenth embodiment of a polarized antenna in the disclosure;

FIG. 16 is a top view of the sixteenth embodiment of a polarized antenna in the disclosure;

FIG. 17 is a perspective view of the seventeenth embodiment of a polarized antenna in the disclosure; and

FIG. 18 is a perspective view of the eighteenth embodiment of a polarized antenna in the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

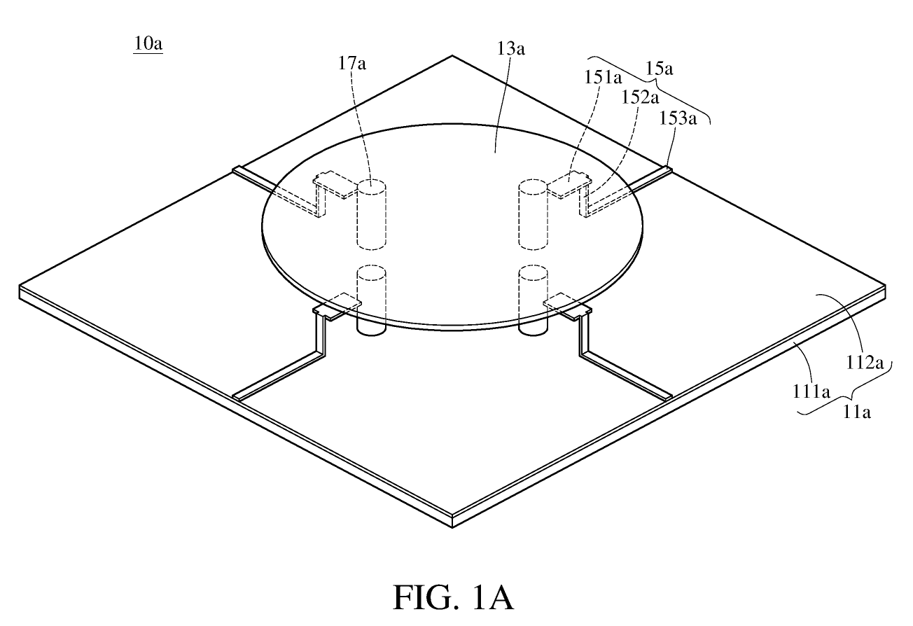

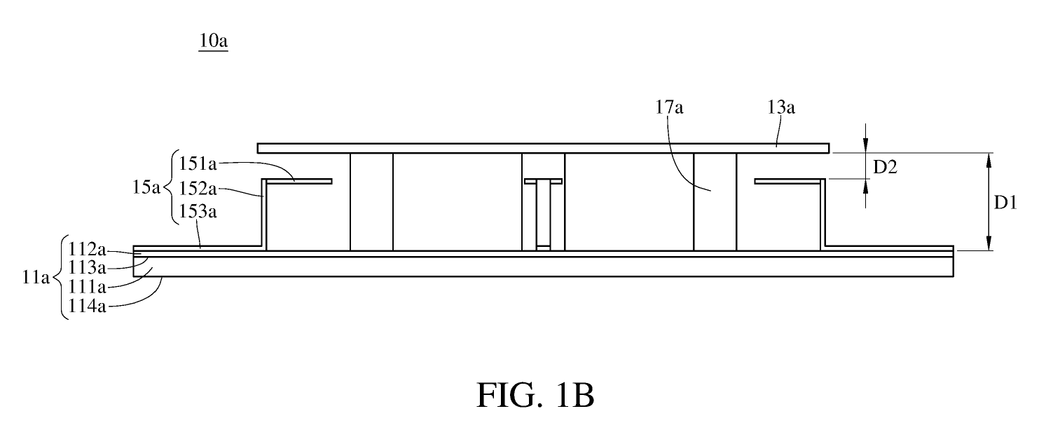

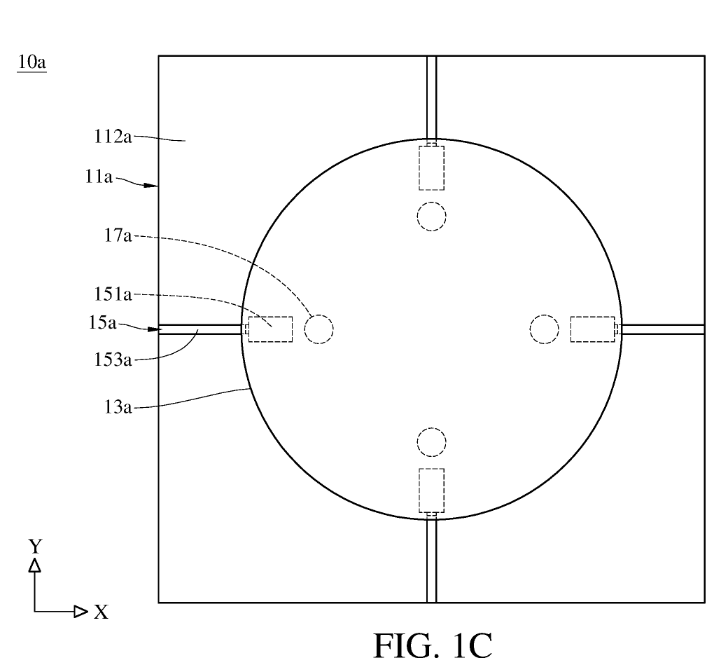

Please refer to FIG. 1A to FIG. 1C. FIG. 1A is a perspective view of the first embodiment of a polarized antenna in the disclosure, FIG. 1B is a side view of the first embodiment of a polarized antenna in the disclosure, and FIG. 1C is a top view of the first embodiment of a polarized antenna in the disclosure. In the figures, a polarized antenna 10a can be applied in a variety of communication devices, such as mobile communication devices, wireless communication devices, mobile computing devices and computer systems, or be applied in telecommunications equipment, network equipment, or peripheral equipment of computer or network.

The polarized antenna 10a includes a load board 11a, a first radiation plate 13a, four feeding parts 15a and four grounded parts 17a. The load board 11a includes a dielectric layer 111a and a conductive layer 112a. The dielectric layer 111a has a first surface 113a and a second surface 114a opposite to the first surface 113a, and they are an upper surface and a lower surface of the dielectric layer 111a and are parallel to each other. The conductive layer 112a is located on the first surface 113a of the dielectric layer 111a. The load board 11a is, for example, a case, inner structure or other suitable part of a communication device, for disposing the first radiation plate 13a, the feeding parts 15a and the grounded parts 17a. In this embodiment, the material of the load board 11a is, for example, a material of an insulating printed circuit board (PCB) substrate, plastic, a ceramic material or another suitable material, but this embodiment is not limited thereto.

The first radiation plate 13a is located above the load board 11a and is close to the first surface 113a of the dielectric layer 111a. There are the grounded parts 17a or other pillars of insulation material existing between the first radiation plate 13a and the conductive layer 112a so that the first radiation plate 13a and the conductive layer 112a have a first resonance gap D1 therebetween. In an embodiment, the first radiation plate 13a and the load board 11a are flat plate structures, and the normal vector of the first radiation plate 13a is substantially parallel to the normal vector of the load board 11a. For example, the width of the first resonance gap D1 is 0.05 times the wavelength corresponding to the resonant frequency band of the polarized antenna 10a, but this embodiment is not limited thereto.

The four feeding parts 15a are located under the first radiation plate 13a and on the conductive layer 112a of the load board 11a, and is insulated from the conductive layer 112a. In this embodiment, each of the feeding parts 15a includes a first conductor section 151a, a second conductor section 152a and a third conductor section 153a. The second conductor section 152a is located between the first conductor section 151a and the third conductor section 153a. The third conductor section 153a touches and is connected to the conductive layer 112a of the load board 11a and is insulated from the conductive layer 112a. The second conductor section 152a is substantially vertically or obliquely connected to an end of the third conductor section 153a, so the first conductor section 151a is farther from the conductive layer 112a of the load board 11a as compared to the third conductor section 153a. In other words, the first conductor section 151a is located between the first radiation plate 13a and the load board 11a and is separated from the load board 11a. The other end of the first conductor section 151a extends away from the third conductor section 153a. In the top view, the first conductor section 151a overlaps the first radiation plate 13a, and the first conductor section 151a is covered by and located under the first radiation plate 13a. In the side view, there is a coupling gap D2 between the second conductor section 152a and the first radiation plate 13a.

In the figures, the first conductor section 151a and the second conductor section 152a are covered by and located under the first radiation plate 13a, a part of the third conductor section 153a is also covered by and located under the first radiation plate 13a. In another embodiment, only a part of the first conductor section 151a is covered by and located under the first radiation plate 13a, but the second conductor section 152a and the third conductor section 153a are not covered by the first radiation plate 13a. In yet another embodiment, when the second conductor section 152a is obliquely disposed on the load board 11a, the first conductor section 151a and a part of the second conductor section 152a are covered by and located under the first radiation plate 13a, but the third conductor section 153a and the other part of the second conductor section 152a are not covered by the first radiation plate 13a. The disclosure is not limited to the above embodiments.

Based on the orientation of the figures, the four feeding parts 15a are sorted into upper, lower, left and right feeding parts 15a, respectively. The orientations of “upper”, “lower”, “left” and “right” are only for clear description rather than limiting the positions of the four feeding parts 15a. The left and right feeding parts 15a extend in a positive direction and a reverse direction along a first preset axis X, and the upper and lower feeding parts 15a extend in a positive direction and a reverse direction along a second preset axis Y. In this embodiment, the extension direction of the feeding part 15a is a direction in which the first conductor section 151a extends away from the third conductor section 153a. In this embodiment, the lower feeding part 15a extends in the positive direction along the second preset axis Y, the upper feeding part 15a extends in the reverse direction along the second preset axis Y; and likewise, the left feeding part 15a extends in the positive direction along the first preset axis X, and the right feeding part 15a extends in the reverse direction along the first preset axis X. In an embodiment, the first preset axis X is substantially vertical to the second preset axis Y, but the disclosure is not limited thereto.

The four grounded parts 17a are located on the load board 11a, and each of the grounded parts 17a is electrically connected to the conductive layer 11a. In this embodiment, the grounded parts 17a are connected to the first radiation plate 13a; in another embodiment, the grounded parts 17a are not connected to the first radiation plate 13a, and the top of the grounded parts 17a and the first radiation plate 13a have a gap therebetween. All of the four grounded parts 17a may not be connected to the first radiation plate 13a; for example, three or less than three of the four grounded parts 17a are connected to the first radiation plate 13a, and the rest of the four grounded parts 17a are not connected to the first radiation plate 13a and have a gap with the first radiation plate 13a; and the embodiment is not limited thereto.

Based on the orientation of the figure, the four grounded parts 17a are sorted to the upper, lower, left and right grounded parts 17a, respectively. Similarly, the orientations of “upper”, “lower”, “left” and “right” are only for clear description rather than limiting the positions of the four grounded parts 17a. The left and right grounded parts 17a are located on a virtual line between the left and right feeding parts 15a and between the left and right feeding parts 15a, and the left grounded part 17a is closer to the left feeding part 15a than the right grounded part 17a. The upper and lower grounded parts 17a are located on a virtual line between the upper and lower feeding parts 15a and between the upper and lower feeding parts 15a, and the upper grounded part 17a is closer to the upper feeding part 15a than the lower grounded part 17a.

In practice, the feeding parts 15a are electrically connected to a signal source, a signal processor or other suitable components through the third conductor section 153a. In the case of a signal processor, the feeding parts 15a receives electromagnetic waves from the first radiation plate 13a and sends the received electromagnetic waves to the signal processor, or sends electromagnetic waves, which the signal processor tries to output, to the first radiation plate 13a. Such a signal processor is, for example, a chip having a radio frequency module, a radio frequency chip or another suitable chip, and this embodiment is not limited thereto.

The feeding part 15a has a feeding point at an end of the first conductor section 151a, which is not connected to the second conductor section 152a, and the feeding part 15a has a signal point at an end of the third conductor section 153a, which is connected to the signal processor. A direction extending from the feeding point to the signal point represents a feeding direction. In this embodiment, the feeding direction of the upper feeding part 15a is substantially vertically to the feeding directions of the left and right feeding parts 15a, so the upper feeding part 15a and the right feeding part 15a respectively correspond to the horizontal polarization work mode and vertical polarization work mode of the polarized antenna 10a, and the upper feeding part 15a and the left feeding part 15a respectively correspond to the horizontal polarization work mode and vertical polarization work mode of the polarized antenna 10a. Similarly, the feeding direction of the lower feeding part 15a is substantially vertical to the feeding directions of the left and right feeding parts 15a, so the lower feeding part 15a and the right feeding part 15a respectively correspond to the horizontal polarization work mode and vertical polarization work mode of the polarized antenna 10a, and the lower feeding part 15a and the left feeding part 15a respectively correspond to the horizontal polarization work mode and vertical polarization work mode of the polarized antenna 10a.

As the polarized antenna 10a tries to receive and transmit electromagnetic waves, the coupling gap D2 between the first conductor section 151a of the feeding part 15a and the first radiation plate 13a could guide the near field energy of the feeding part 15a to the first radiation plate 13a, so the first conductor section 151a, the second conductor section 152a, the third conductor section 153a of the feeding part 15a and the first radiation plate 13a constitute a resonance path. The resonance configuration of the resonance paths forms the resonant frequency band of the polarized antenna 10a, so the signal processor employs the feeding parts 15a and the first radiation plate 13a to receive and transmit electromagnetic wave signals of a communication device in the resonant frequency band. The frequencies of the resonant frequency band are related to the length of the resonance path; for example, the length of the resonance path is one half times the wavelength corresponding to the resonant frequency band of the polarized antenna 10a, but this embodiment is not limited thereto.

In an embodiment, in the polarized antenna 10a, the length of the resonance path is adjustable according to the lengths of the first conductor section 151a, the second conductor section 152a and the third conductor section 153a of the feeding part 15a and the diameter of the first radiation plate 13a. Moreover, the resonance paths each constituted by one of the four feeding parts 15a and the first radiation plate 13a would form the same resonant frequency band, or two of the resonance paths of the four feeding parts 15a would cause the same resonant frequency band, or the resonance path of each of the four feeding parts 15a would cause a different resonant frequency band, and this embodiment is not limited thereto. In an embodiment, when each of the four feeding parts 15a causes a different resonant frequency band, two adjacent resonant frequency bands at least cover the same band of frequencies for a communication system.

The four grounded parts 17a are located between the four feeding parts 15a and electrically connected to the conductive layer 112a and the signal ground end. The grounded parts 17a play a role to insulate the four feeding parts 15a from each other to efficiently shorten the resonance paths respectively constituted by the four feeding parts 15a and the first radiation plate 13a and reduce the interference from the resonant modes of the resonance paths, so as to enhance the insulation that the four feeding parts 15a are feeding signals.

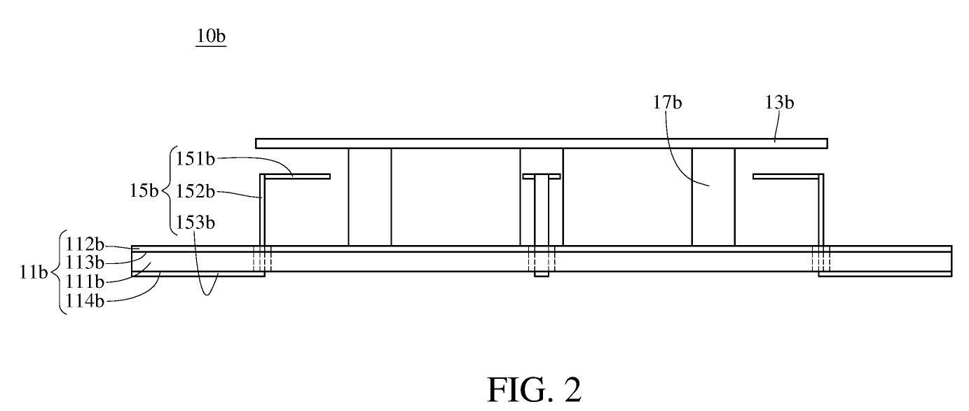

Next, other embodiments of the polarized antenna are described as follows. Please refer to FIG. 2. FIG. 2 is a side view of the second embodiment of a polarized antenna in the disclosure. As shown in FIG. 2, a polarized antenna 10b includes a load board 11b, a first radiation plate 13b, four feeding parts 15b and four grounded parts 17b. The load board 11b includes a dielectric layer 111b and a conductive layer 112b. The dielectric layer 111b has a first surface 113b and a second surface 114b opposite to the first surface 113b, i.e. the upper and lower parallel surfaces of the dielectric layer 111a. The conductive layer 112b is located on the first surface 113b of the dielectric layer 111b. The first radiation plate 13b is disposed above the load board 11b through the support of the grounded parts 17b or other pillars of insulation material and is close to the first surface 113b of the dielectric layer 111b, so the first radiation plate 13b and the conductive layer 112b have a first resonance gap therebetween. In an embodiment, the first radiation plate 13b and the load board 11b are flat plate structures, and the normal vector of the first radiation plate 13b is substantially parallel to the normal vector of the load board 11b.

The four feeding parts 15b are located on the load board 11b, and each of the feeding parts 15b includes a first conductor section 151b, a second conductor section 152b and a third conductor section 153b. The second conductor section 152b is located between the first conductor section 151b and the third conductor section 153b. The first conductor section 151b is located above the load board 11b and is close to the first surface 113b of the dielectric layer 111b. The second conductor section 152b passes through the load board 11b. The third conductor section 153b touches and is connected to the second surface 114b of the dielectric layer 111b. The third conductor section 153b is insulated from the conductive layer 112b. Similar to the previous embodiment, the first conductor section 151b and the second conductor section 152b are covered by and located under the first radiation plate 13b, and a part of the third conductor section 153b is also covered by and located under the first radiation plate 13b; but this embodiment is not limited thereto. In the side view, the first conductor section 151b and the first radiation plate 13b have a coupling gap therebetween.

The four grounded parts 17b are located on the load board 11b and connected to the conductive layer 112b. In this embodiment, the grounded parts 17b are connected to the first radiation plate 13b; and however, in another embodiment, one or more of the grounded parts 17b may not be connected to the first radiation plate 13b, and the top of the grounded part 17b and the first radiation plate 13b have a gap therebetween. The four grounded parts 17b are located between the four feeding parts 15b and electrically connected to the conductive layer 112b, so the four grounded parts play a role to insulate the four feeding parts 15b from each other, so as to shorten the resonance paths respectively constituted by the four feeding parts 15b and the first radiation plate 13b and reduce the interference between the resonance paths. Therefore, the insulation that the four feeding parts 15b are feeding signal may be enhanced.

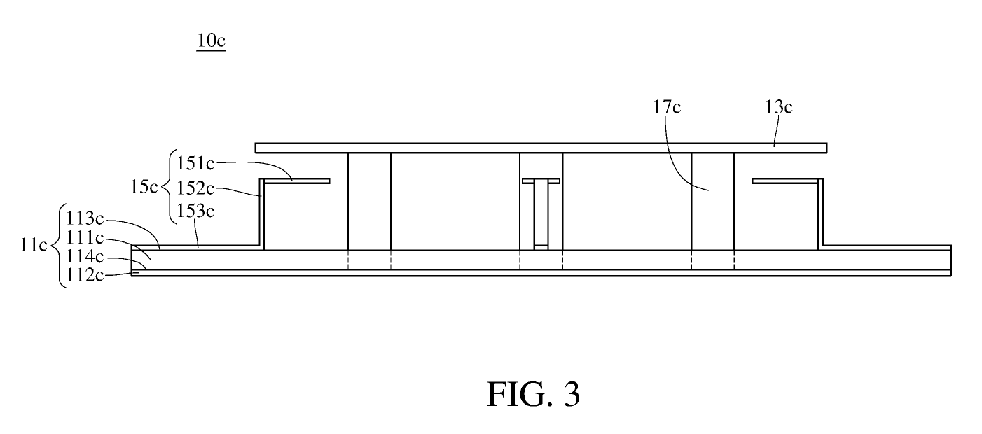

Please refer to FIG. 3. FIG. 3 is a side view of the third embodiment of a polarized antenna in the disclosure. As shown in FIG. 3, a polarized antenna 10c includes a load board 11c, a first radiation plate 13c, four feeding parts 15c and four grounded parts 17c. The load board 11c, the first radiation plate 13c, the four feeding parts 15c and the four grounded parts 17c are substantially the same as the relevant components in the first embodiment, respectively. Differences between the first and third embodiments include: a conductive layer 112c is located on a second surface 114c of a dielectric layer 111c, and the four feeding parts 15c are located on a first surface 113c of the dielectric layer 111c, and since the conductive layer 112c and each feeding part 15c are respectively disposed on two opposite surfaces of the load board 11c, the conductive layer 112c is insulated from each feeding part 15c. In this embodiment, the four grounded parts 17c are located on the first surface 113c of the dielectric layer 111c and pass through the load board 11c, so as to be electrically connected to the conductive layer 112c.

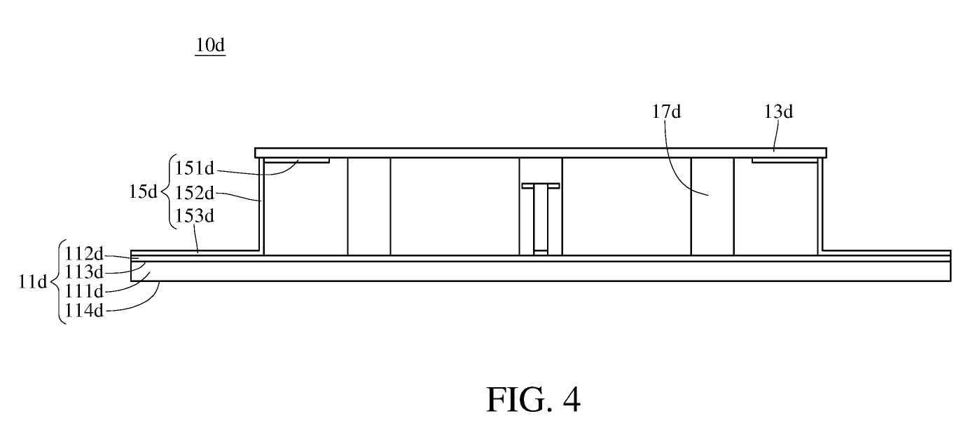

Please refer to FIG. 4. FIG. 4 is a side view of the fourth embodiment of a polarized antenna in the disclosure. As shown in FIG. 4, a polarized antenna 10d includes a load board 11d, a first radiation plate 13d, four feeding parts 15d and four grounded parts 17d. The load board 11d, the first radiation plate 13d, the four feeding parts 15d and the four grounded parts 17d are substantially the same as the relevant components in the first embodiment, respectively. Differences between the first and fourth embodiments include: a first conductor section 151d of the feeding part 15d touches the first radiation plate 13d.

Likewise, the first conductor section may touch the first radiation plate in the second and third embodiments, so as to produce two other embodiments, which are not repeated hereinafter. The connection between the first conductor section 151d and the first radiation plate 13d is carried out by, for example, a metal fastener, welding or other suitable manners. The feeding part 15d can touch the first radiation plate 13d via the first conductor section 151d to constitute a resonance path with the first radiation plate 13d by a directly feeding manner, and the resonance paths form a resonant frequency band of the polarized antenna 10d. Therefore, the signal processor can receive or transmit electromagnetic wave signals of a communication device in the resonant frequency band via the feeding parts 15d and the first radiation plate 13d.

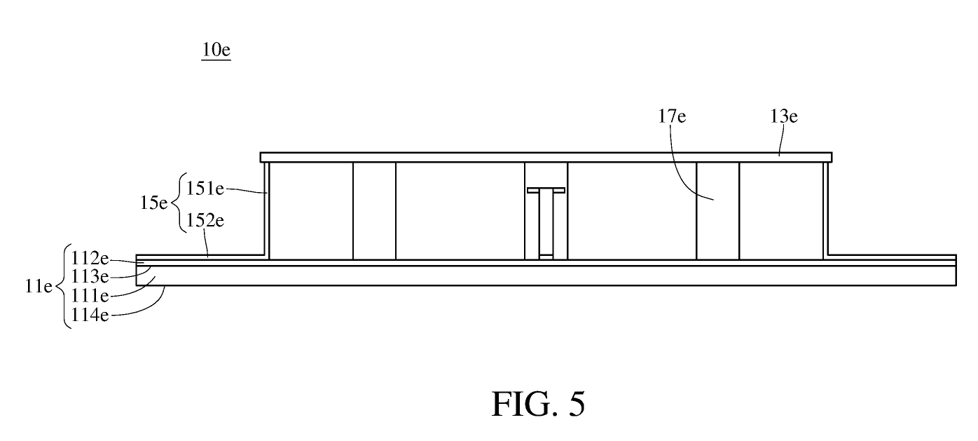

However, the first conductor section 151d may be removed from the design of the fourth embodiment. Please refer to FIG. 5. FIG. 5 is a side view of the fifth embodiment of a polarized antenna in the disclosure. As shown in FIG. 5, a polarized antenna 10e includes a load board 11e, a first radiation plate 13e, four feeding parts 15e and four grounded parts 17e. The load board 11e includes a dielectric layer 111e and a conductive layer 112e. The dielectric layer 111e has a first surface 113e and a second surface 114e opposite to the first surface 113e, and the conductive layer 112e is located on the first surface 113e of the dielectric layer 111e.

The four feeding parts 15e are located under the first radiation plate 13e and located on the conductive layer 112e of the load board 11e and are insulated from the conductive layer 112e. In this embodiment, each of feeding parts 15e includes a first end 151e and a second end 152e. The second end 152e touches and is connected to the conductive layer 112e of the load board 11e, and the second end 152e is insulated from the conductive layer 112e. The first end 151e is substantially vertically disposed on the load board 11e or is obliquely disposed on the load board 11e, and the first end 151e touches the first radiation plate 13e.

In the figure, the first end 151e and a part of the second end 152e are covered by and located under the first radiation plate 13e. In another embodiment, a second conductor section is obliquely disposed on the load board 11e, a part of the first end 151e is covered by and located under the first radiation plate 13e, and the second end 152e is not covered by the first radiation plate 13e; this embodiment is not limited thereto.

The second end 152e of the feeding part 15e is insulated from the conductive layer 112e. In addition to the manner shown in FIG. 5, any person having ordinary skill in the art can modify the second end 152e and the conductive layer 112e in FIG. 5 in view of the embodiments shown in FIG. 2 and FIG. 3, and it will not be repeated herein.

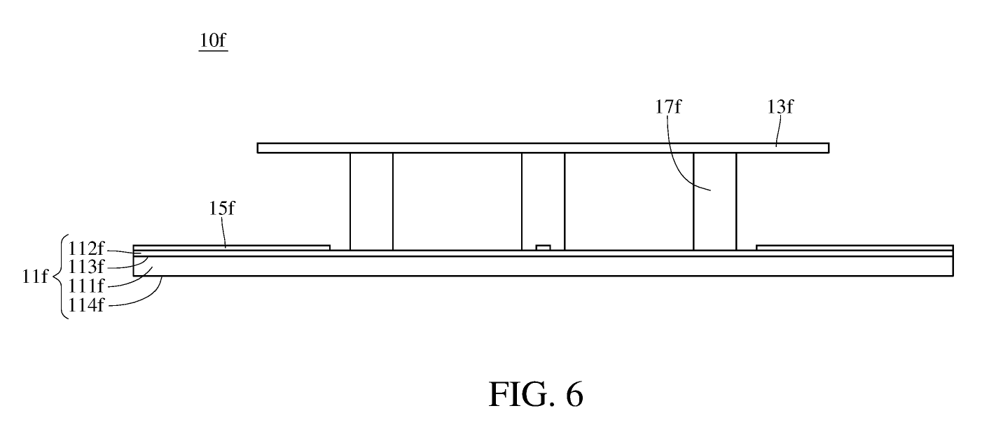

Then, other types of the feeding part are contemplated. Please refer to FIG. 6. FIG. 6 is a side view of the sixth embodiment of a polarized antenna in the disclosure. As shown in FIG. 6, a polarized antenna 10f includes a load board 11f, a first radiation plate 13f, four feeding parts 15f and four grounded parts 17f. The load board 11f includes a dielectric layer 111f and a conductive layer 112f, and the dielectric layer 111f has a first surface 113f and a second surface 114f opposite to the first surface 113f. The conductive layer 112f is located on the first surface 113f of the dielectric layer 111f. The first radiation plate 13f is located above the load board 11f and is close to the first surface 113f of the dielectric layer 111f. The first radiation plate 13f and the conductive layer 112f have a first resonance gap therebetween because of the support of the grounded parts 17f or other pillars of insulation material. In this embodiment, the first radiation plate 13f and the load board 11f are flat plate structures, and the normal vector of the first radiation plate 13f is substantially parallel to the normal vector of the load board 11f.

The four feeding parts 15f are located under the first radiation plate 13f and located on the conductive layer 112f of the load board 11f, and the four feeding parts 15f are insulated from the conductive layer 112f. In this embodiment, a part of the feeding part 15f is covered by and located under the first radiation plate 13f, and the part of the feeding part 15f covered by the first radiation plate 13f has a coupling gap with the first radiation plate 13f. When the polarized antenna 10f would like to electromagnetic waves, the coupling gap between the feeding part 15f and the first radiation plate 13f can guide the energy on the feeding part 15f to the first radiation plate 13f, so the feeding part 15f and the first radiation plate 13f together form a resonance path. The resonance configuration of the resonance paths forms a resonant frequency band of the polarized antenna 10f, so the signal processor can receive and transmit electromagnetic wave signals of a communication device in the resonant frequency band via the feeding parts 15f and the first radiation plate 13f. The resonant frequency band of the polarized antenna 10f is related to the coupling gap between the feeding parts 15f and the first radiation plate 13f.

The four grounded parts 17f are located between the four feeding parts 15f and electrically connected to the conductive layer 112f, so as to be electrically connected to a signal ground end. The grounded parts 17f play a role to insulate the four feeding parts 15f from each other, so as to efficiently shorten the resonance paths respectively constituted by the four feeding parts 15f and the first radiation plate 13f and reduce the interference from the resonant modes of the resonance paths. Therefore, the insulation that the four feeding parts 15f are feeding signals may be enhanced. In this embodiment, the four grounded parts 17f are connected to the first radiation plate 13f; in another embodiment, the grounded parts 17f are separated from the first radiation plate 13f, so the grounded parts 17f have a gap with the first radiation plate 13f. In yet another embodiment, a part of the four grounded parts 17f is connected to the first radiation plate 13f, and the other part of the four grounded parts 17f has a gap with the first radiation plate 13f, and this embodiment is not limited thereto.

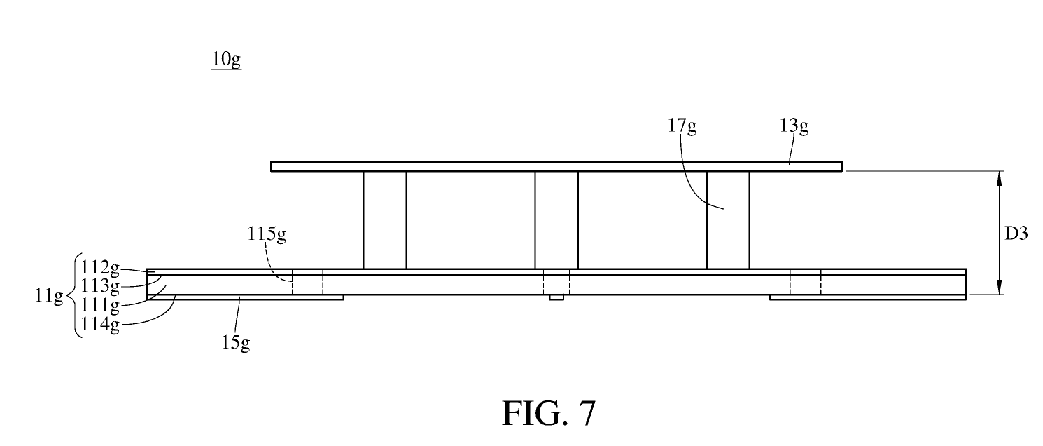

Please refer to FIG. 7. FIG. 7 is a side view of the seventh embodiment of a polarized antenna in the disclosure. As shown in FIG. 7, a polarized antenna 10g includes a load board 11g, a first radiation plate 13g, four feeding parts 15g and four grounded parts 17g. The load board 11g includes a dielectric layer 111g, a conductive layer 112g and four through holes 115g. The dielectric layer 111g has a first surface 113g and a second surface 114g opposite to the first surface 113g. The conductive layer 112g is located on the first surface 113g of the dielectric layer 111g. The first radiation plate 13g is located above the load board 11g and is close to the first surface 113g of the dielectric layer 111g. The first radiation plate 13g and the conductive layer 112g have a first resonance gap therebetween via the support of the grounded parts 17g or other pillars of insulation material. In this embodiment, the first radiation plate 13g and the load board 11g are flat plate structures, and the normal vector of the first radiation plate 13g is substantially parallel to the normal vector of the load board 11g. The four through holes 115g pass through the dielectric layer 111g and the conductive layer 112g and are covered by and located under the first radiation plate 13g.

The four feeding parts 15g are located under the first radiation plate 13g and located on the second surface 114g of the dielectric layer 111g. At least a part of each of the feeding parts 15g overlaps the related through hole 115g. In this embodiment, the overlap between the feeding part 15g and the through hole 115g is also covered by and located under the first radiation plate 13g. Via the through holes 115g, the feeding parts 15g have a coupling gap D3 with the first radiation plate 13g. When the polarized antenna 10g would like to receive or transmit electromagnetic waves, the coupling gap between the feeding parts 15g and the first radiation plate 13g can guide the energy on the feeding parts 15g to the first radiation plate 13g, so the feeding part 15g and the first radiation plate 13g constitute a resonance path, thereby forming a resonant frequency band of the polarized antenna 10g. Therefore, the signal processor receives and transmits electromagnetic wave signals of a communication device in the resonant frequency band via the feeding parts 15g and the first radiation plate 13g.

The four grounded parts 17g are located between the four feeding parts 15g and electrically connected to the conductive layer 112g, so as to be electrically connected to a signal ground end and play a role to insulate the four feeding parts 15g from each other. Similar to the previous embodiment, whether the four grounded parts 17g are connected to the first radiation plate 13g or not can be designed according to a variety of actual requirements, and this embodiment has no limitation thereon.

In the previous embodiments, the amount of feeding parts and the amount of grounded parts are 4 as examples. In practice, the amount of feeding parts is M, the amount of grounded parts is N, M is a positive integer larger than 2, and N is a positive integer larger than 1. Moreover, this embodiment has no limitation on the amounts and positions of feeding parts and grounded parts. Other embodiments based on a variety of amounts and a variety of positions of the grounded part are illustrated below.

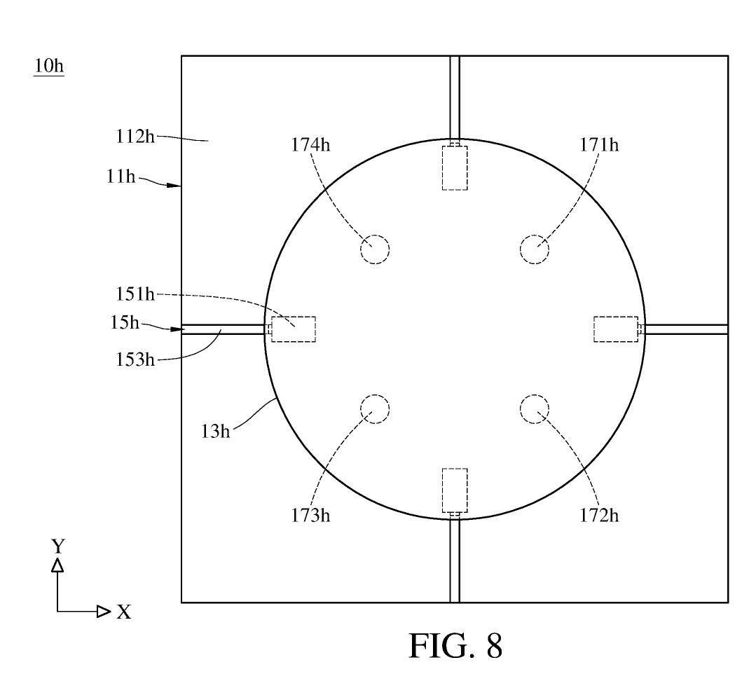

Please refer to FIG. 8. FIG. 8 is a top view of the eighth embodiment of a polarized antenna in the disclosure. As shown in FIG. 8, a polarized antenna 10h includes a load board 11h, a first radiation plate 13h, four feeding parts 15h and four grounded parts 17h. The load board 11h, the first radiation plate 13h and the four feeding parts 15h could be carried out by the previous embodiments. In this embodiment, based on the orientation of the figure, the four feeding parts 15h are sorted to the upper, lower, left and right feeding parts 15h, and the orientations of “upper”, “lower”, “left” and “right” are only for clear description rather than limiting the positions of the feeding parts 15h. The left and right feeding parts 15h extend in a positive direction and a reverse direction along the first preset axis X, and the upper and lower feeding parts 15h extend in a positive direction and a reverse direction along the second preset axis Y.

The four grounded parts 17h are sorted to a first grounded part 171h, a second grounded part 172h, a third grounded part 173h and a fourth grounded part 174h. The first grounded part 171h, the second grounded part 172h, the third grounded part 173h and the fourth grounded part 174h are covered by and located under the first radiation plate 13h. The first grounded part 171h is located in between the positive direction on the first preset axis X and the positive direction on the second preset axis Y, the second grounded part 172h is located in between the positive direction on the first preset axis X and the reverse direction on the second preset axis Y, the third grounded part 173h is located in between the reverse direction on the first preset axis X and the reverse direction on the second preset axis Y, and the fourth grounded part 174h is located in between the reverse direction on the first preset axis X and the positive direction on the second preset axis Y.

In an embodiment, if a path from the center point of the first radiation plate 13h as a base point to the upper feeding part 15h represents a 0° angle, the first grounded part 171h is located on a path represented by a clockwise angle of 45°, the second grounded part 172h is located on a path represented by a clockwise angle of 135°, the fourth grounded part 174h is located on a path represented by an anticlockwise angle of 45°, the third grounded part 173h is located on a path represented by an anticlockwise angle of 135°, and the first grounded part 171h, the second grounded part 172h, the third grounded part 173h and the fourth grounded part 174h have the same distance with the base point. The foregoing angles of 45° and 135° are only for clear explanation and concise drawing rather than limiting the embodiment; and other embodiments may be contemplated in which the foregoing angles of 45° and 135° are replaced by other angles, and have no limitation on them.

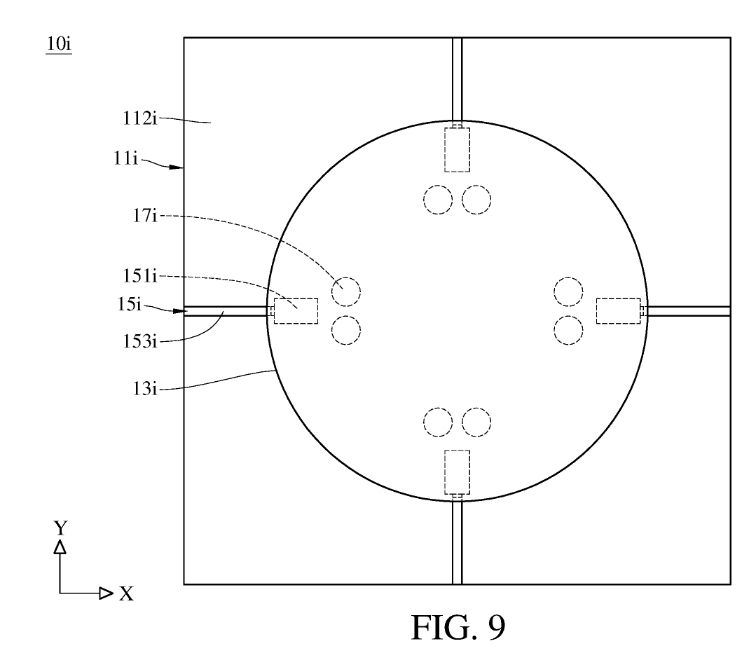

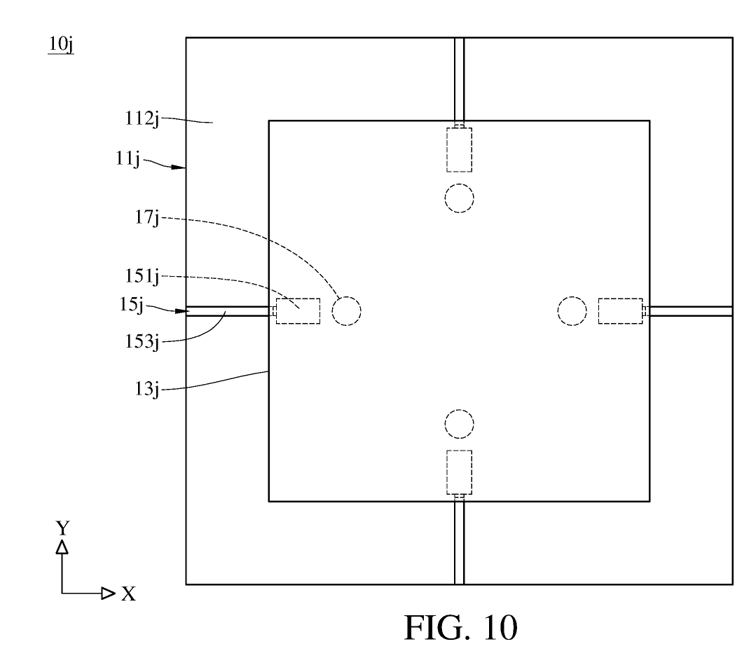

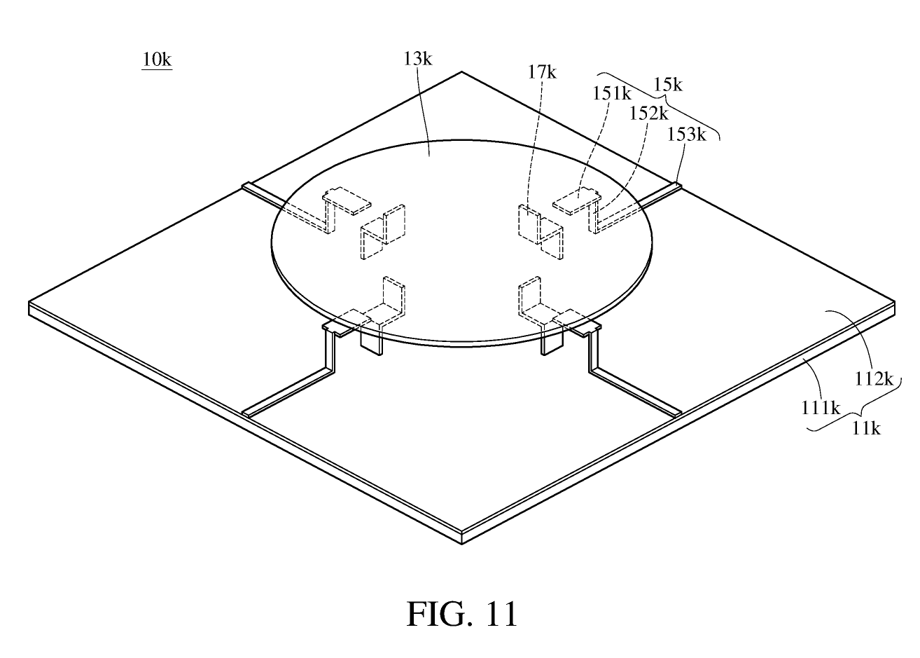

In other embodiments, the amount and shape of the grounded part, the shape of the load board and the shape of the first radiation plate can be designed according to a variety of actual requirements. Please refer to FIG. 9 to FIG. 11. FIG. 9 is a top view of the ninth embodiment of a polarized antenna in the disclosure, FIG. 10 is a top view of the tenth embodiment of a polarized antenna in the disclosure, and FIG. 11 is a perspective view of the eleventh embodiment of a polarized antenna in the disclosure. For example, the amount of the grounded part 17i is designed as shown in FIG. 9, the shape of the first radiation plate 13k is designed as shown in FIG. 10, and the shape of the grounded part 17k is designed as shown in FIG. 11.

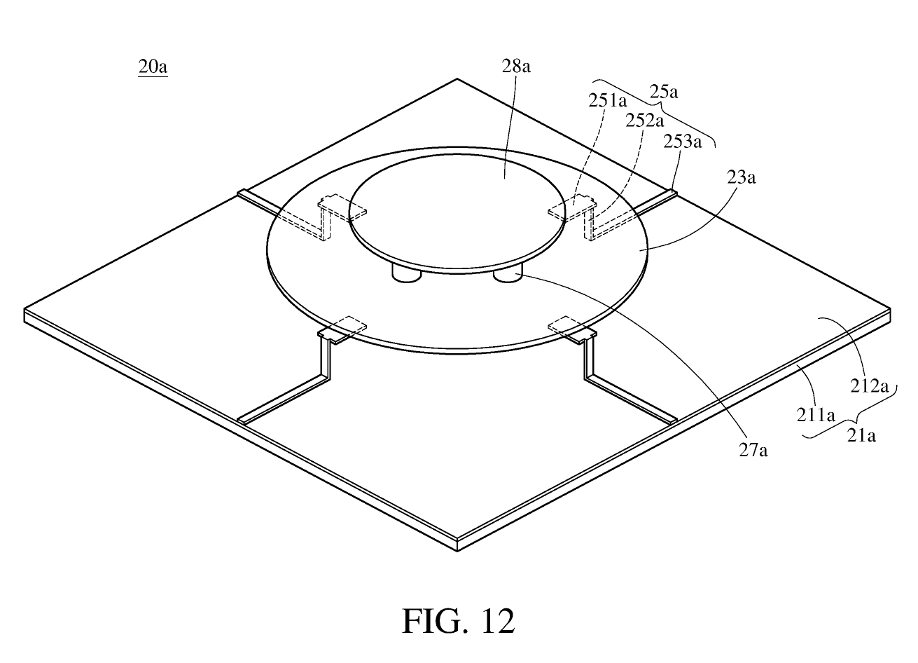

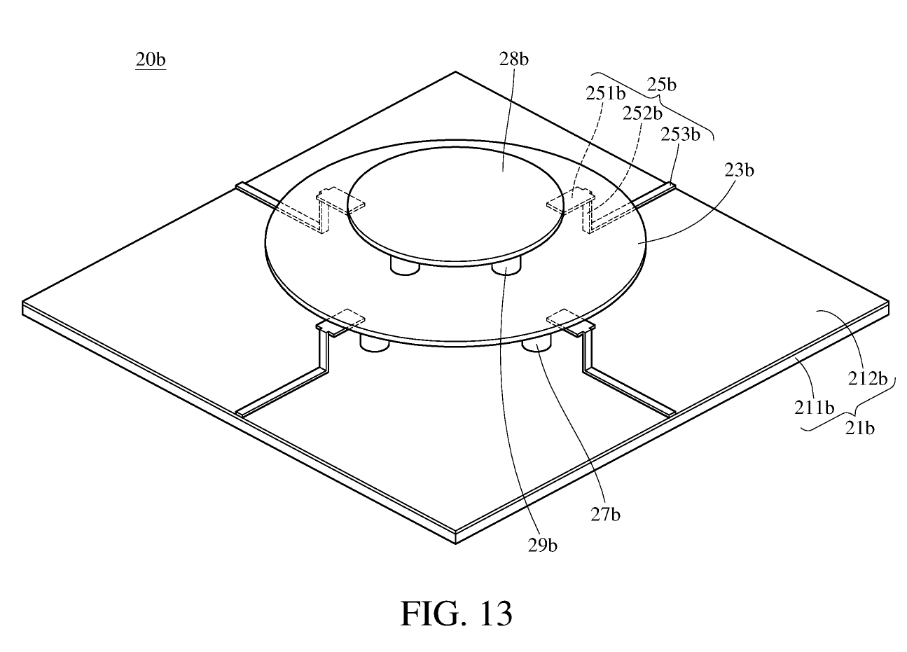

Please refer to FIG. 12 and FIG. 13. FIG. 12 is a perspective view of the twelfth embodiment of a polarized antenna in the disclosure, and FIG. 13 is a perspective view of the thirteenth embodiment of a polarized antenna in the disclosure. In view of the figures, a polarized antenna 20a includes a load board 21a, a first radiation plate 23a, M pieces of feeding part 25a, N pieces of grounded part 27a and a second radiation plate 28a. The load board 21a, the first radiation plate 23a, the M pieces of feeding part 25a and the N pieces of grounded part 27a could be carried out by the previous embodiments. In this embodiment, the second radiation plate 28a is located above the first radiation plate 23a and has a second resonance gap with the first radiation plate 23a.

The second radiation plate 28a is disposed above the first radiation plate 23a via the support of one or more grounded parts 27a, and the grounded part 27a passes through the first radiation plate 23a and is connected to the second radiation plate 28a, as shown in FIG. 12. In another embodiment, as shown in FIG. 13, a polarized antenna 20b further includes P pieces of connecting part 29b, and a second radiation plate 28b is disposed above a first radiation plate 23b via the support of the P pieces of connecting part 29b, where P is a positive integer. The material of the connecting part 29b is, for example, metal conductor or an insulation material, and the embodiment is not limited thereto. In an embodiment, the width of a second resonance gap between the second radiation plate 28b and the first radiation plate 23b is smaller than or substantially equal to the width of a first resonance gap between the first radiation plate 23b and a load board 21b.

When the polarized antenna would like to receive or transmit electromagnetic waves, the second resonance gap between the second radiation plate 28b and the first radiation plate 23b could couple the near field energy on the first radiation plate 23b to the second radiation plate 28b, so the feeding part 25b, the first radiation plate 23b and the second radiation plate 28b institute a resonance path, so as to form a resonant frequency band of the polarized antenna 20b. In an embodiment, the diameter of the first radiation plate 23b and the diameter of the second radiation plate 28b are related to the distance between the first radiation plate 23b and the second radiation plate 28b. In another embodiment, the diameter of the first radiation plate 23b and the diameter of the second radiation plate 28b are related to the N pieces of grounded part 27b. In yet another embodiment, the diameter of the first radiation plate 23b and the diameter of the second radiation plate 28b are 0.3˜0.7 times the wavelength corresponding to the resonant frequency band, but this embodiment is not limited thereto.

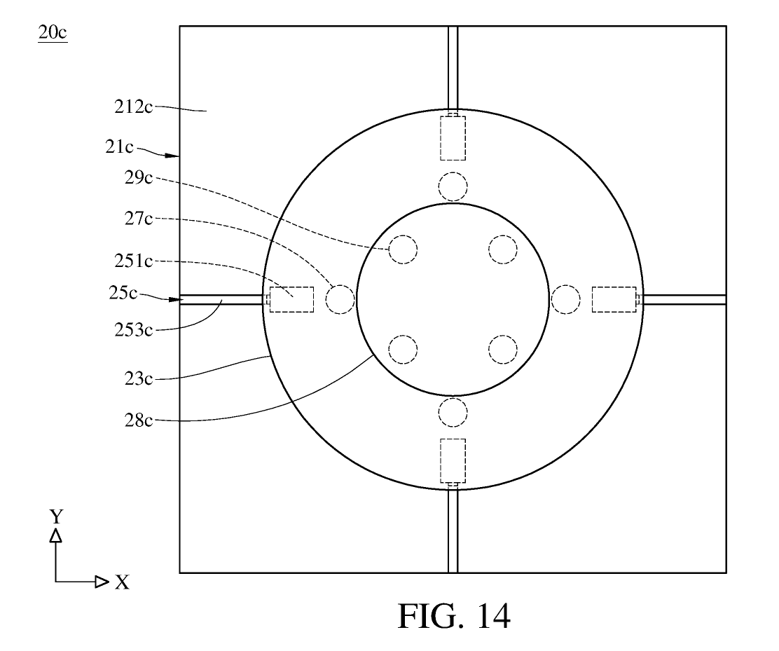

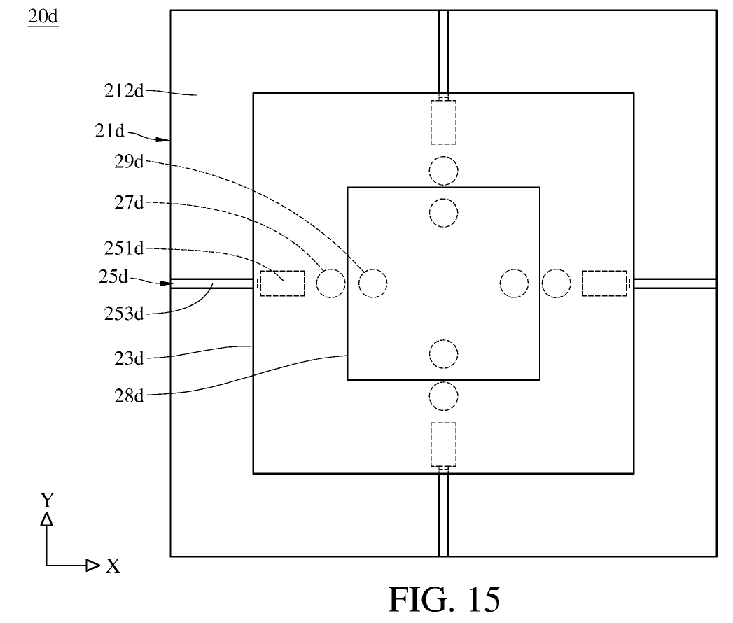

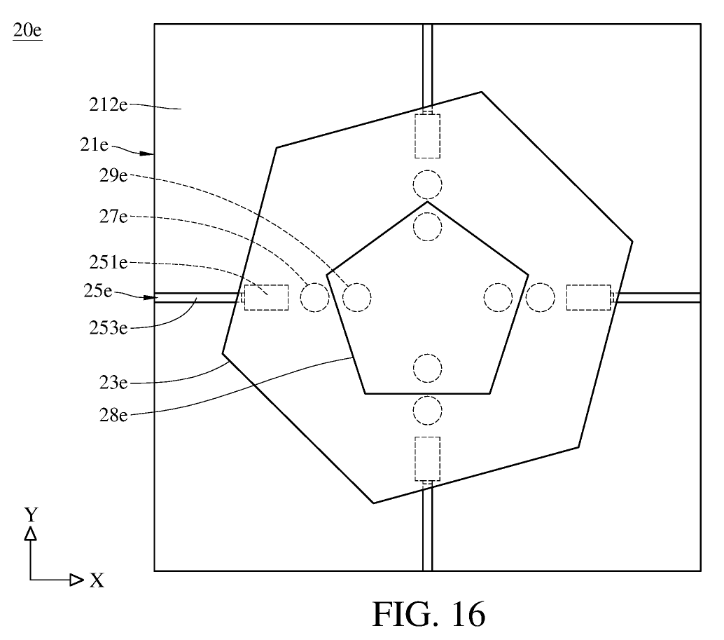

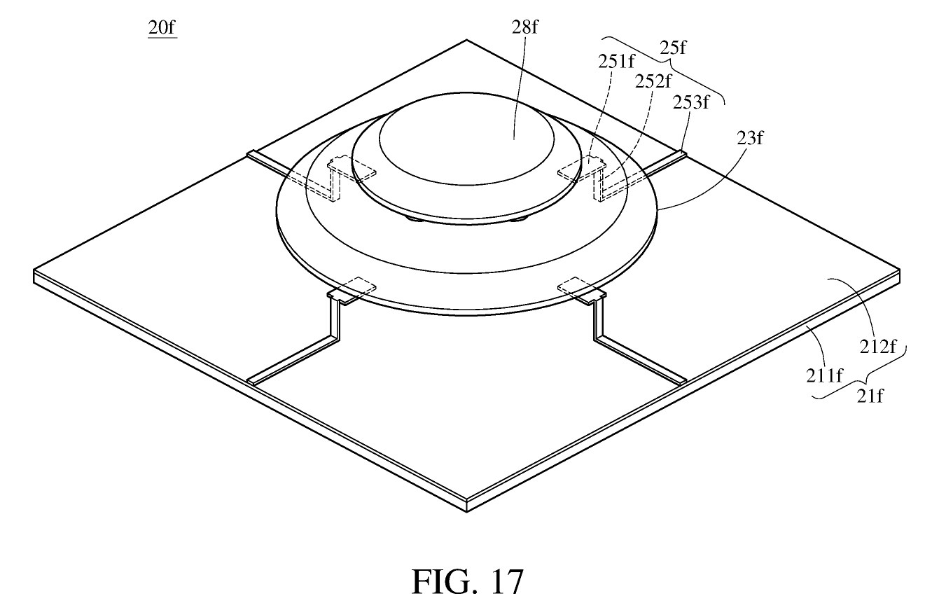

Other types of second radiation plate in the polarized antenna may be contemplated. Please refer to FIG. 14 to FIG. 17. FIG. 14 is a top view of the fourteenth embodiment of a polarized antenna in the disclosure, FIG. 15 is a top view of the fifteenth embodiment of a polarized antenna in the disclosure, FIG. 16 is a top view of the sixteenth embodiment of a polarized antenna in the disclosure, and FIG. 17 is a perspective view of the seventeenth embodiment of a polarized antenna in the disclosure. In the embodiments shown in FIG. 14 to FIG. 17, the shapes, amount and positions of the load board, the first radiation plate, the feeding parts and the grounded parts can be designed according to a variety of actual requirements. For example, the relative position of the connecting parts 29c and the grounded parts 27c can be designed as shown in FIG. 14, and the shape of the first radiation plate and the shape of the second radiation plate can be designed as FIG. 15 to FIG. 17; and these embodiments are not limited thereto. In an embodiment, the shapes of the first and second radiation plates are symmetrical shapes, such as round shape, quadrangle, pentagon or hexagon.

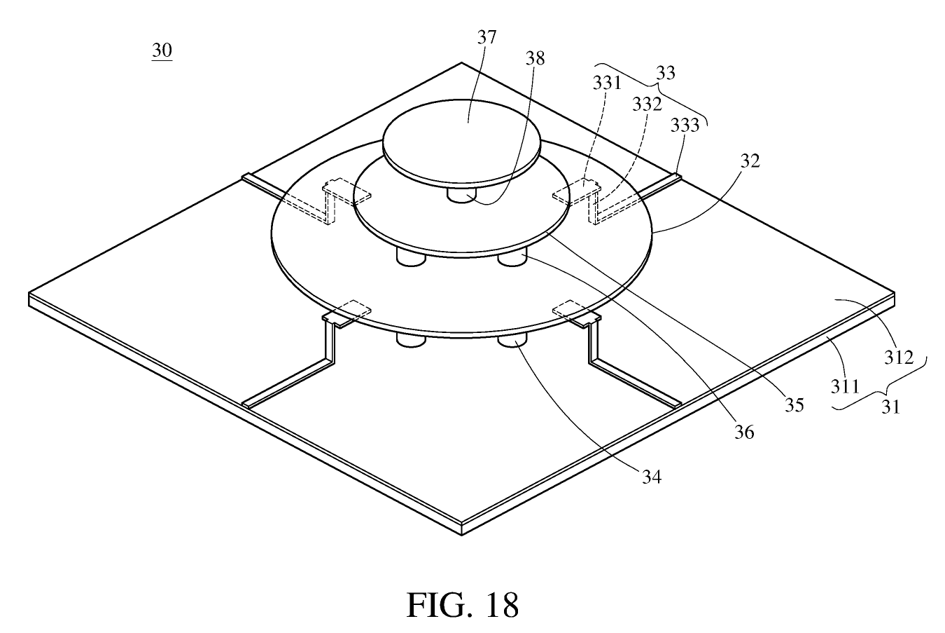

Please refer to FIG. 18. FIG. 18 is a perspective view of the eighteenth embodiment of a polarized antenna in the disclosure. As shown in FIG. 18, a polarized antenna 30 includes a load board 31, a first radiation plate 32, M pieces of feeding part 33, N pieces of grounded part 34, a second radiation plate 35, P pieces of first connecting part 36, a third radiation plate 37 and R pieces of second connecting part 38, where P and R are positive integers. The load board 31, the first radiation plate 32, the M pieces of feeding part 33 and the N pieces of grounded part 34 could be carried out by the previous embodiments. In this embodiment, the third radiation plate 37 is disposed above the second radiation plate 35 via the support of the second connecting part 38 and has a third resonance gap with the second radiation plate 35. As an example, the amount of the second connecting part 38 is one, and the second connecting part 38 is located at the center of the third radiation plate 37. The material of the second connecting part 38 is, for example, plastic or another suitable insulation material.

In this embodiment, the width of the third resonance gap between the third radiation plate 37 and the second radiation plate 35 is smaller than or substantially equal to the width of the first resonance gap between the first radiation plate 32 and the load board 31, and the disposition of the third radiation plate 37 may enhance the gain value and directivity of the polarized antenna 30.

In summary, the disclosure provides a polarized antenna, in which three or more than three feeding parts are disposed to receive electromagnetic waves in a variety of directions of electric field and two or more than two grounded parts are disposed as an insulation manner to shorten the resonance paths constituted by the feeding parts and the first radiation plate and reduce the interference from the resonant modes of the resonance paths, so as to enhance the receiver insulation.

What is claimed is:

1. A multiple polarized antenna, comprising:
a load board comprising a conductive layer;
a first radiation plate located above the load board and having a first resonance gap with the conductive layer;
M pieces of feeding part located under the first radiation plate and insulated from the conductive layer, at least a part of each of the feeding parts being covered by and located under the first radiation plate, the feeding part configured to have signal transmission with the first radiation plate, wherein M is a positive integer larger than 2; and
N pieces of grounded part disposed on the load board and electrically connected to the conductive layer, wherein N is a positive integer larger than 1.

2. The polarized antenna according to claim 1, wherein the part of each of the feeding parts, covered by and located under the first radiation plate and the first radiation plate have at least one coupling gap therebetween.

3. The polarized antenna according to claim 2, wherein each of the feeding parts comprises a first conductor section, a second conductor section and a third conductor section, the second conductor section is located between the first conductor section and the third conductor section, the third conductor section touches the load board, the first conductor section is located between the first radiation plate and the load board and is separated from the load board.

4. The polarized antenna according to claim 3, wherein the load board further comprises a dielectric layer, the dielectric layer has a first surface and a second surface opposite to the first surface, and as the conductive layer is located on the first surface of the dielectric layer, the third conductor section is located on the second surface of the dielectric layer.

5. The polarized antenna according to claim 3, wherein at least one of the first, second and third conductor sections is covered by and located under the first radiation plate and is substantially parallel to the first conductor section and the first radiation plate.

6. The polarized antenna according to claim 5, wherein the first conductor section touches the first radiation plate.

7. The polarized antenna according to claim 3, wherein at least a part of the first conductor section is covered by and located under the first radiation plate, and the first conductor section is substantially parallel to the first radiation plate.

8. The polarized antenna according to claim 7, wherein the first conductor section touches the first radiation plate.

9. The polarized antenna according to claim 2, wherein each of the feeding parts comprises a first end and a second end, the second end touches the load board, the first end touches the first radiation plate, and at least a part of the second end is covered by and located under the first radiation plate.

10. The polarized antenna according to claim 9, wherein the load board further comprises a dielectric layer, the dielectric layer has a first surface and a second surface opposite to the first surface, and as the conductive layer is located on the first surface of the dielectric layer, the second end is located on the second surface of the dielectric layer.

11. The polarized antenna according to claim 1, wherein there are M pieces of through hole within the load board, the M pieces of through hole are covered by and located under the first radiation plate, at least a part of each of the feeding parts overlaps one of the through holes, the part of each of the feeding parts overlapping the through hole transmits signals with the first radiation plate through the through hole.

12. The polarized antenna according to claim 1, further comprising:
a second radiation plate located above the first radiation plate and having a second resonance gap with the first radiation plate, and a width of the second resonance gap being smaller than or substantially equal to a width of the first resonance gap.

13. The polarized antenna according to claim 12, further comprising:
a third radiation plate located above the second radiation plate and having a third resonance gap with the second radiation plate, and a width of the third resonance gap being smaller than or substantially equal to the width of the first resonance gap.

14. The polarized antenna according to claim 13, wherein the first radiation plate, the second radiation plate and the third radiation plate have a respective symmetrical shape.

15. The polarized antenna according to claim 12, wherein at least one of the N pieces of grounded part is connected to the first radiation plate and the second radiation plate.

16. The polarized antenna according to claim 12, further comprising:
P pieces of connecting part connected to and located between the first radiation plate and the second radiation plate, wherein P is a positive integer.

17. The polarized antenna according to claim 16, wherein the N pieces of grounded part are separated from the first radiation plate.

18. The polarized antenna according to claim 1, wherein each of the feeding parts transmits and receives signals in a feeding direction; when an amount of the feeding part is 4 and an amount of the grounded part is 4, the feeding directions of two of the four feeding parts are respectively a positive direction and a reverse direction along a first preset axis, and the feeding directions of the others of the four feeding parts are respectively a positive direction and a reverse direction along a second preset axis.

19. The polarized antenna according to claim 18, wherein the first preset axis is substantially vertical to the second preset axis.

20. The polarized antenna according to claim 19, wherein each of the grounded parts is located between the two feeding parts in the first preset axis or between the two feeding parts in the second preset axis.
